(19) United States
(12) Patent Application Publication
(10) Pub. No.: US 2013/0095397 A1
(43) Pub. Date: Apr. 18, 2013

(54) Ejector

(71) Applicant: HONDA MOTOR CO., LTD., Tokyo (JP)

(72) Inventors: Kazunori Fukuma, Saitama (JP); Mitsuru Kai, Saitama (JP); Satoshi Inoue, Saitama (JP); Kouji Miyano, Saitama (JP)

(73) Assignee: HONDA MOTOR CO., LTD., Tokyo (JP)

(21) Appl. No.: 13/692,505

(22) Filed: Dec. 3, 2012

Related U.S. Application Data
(62) Division of application No. 11/391,169, filed on Mar. 27, 2006.

(30) Foreign Application Priority Data
Mar. 28, 2005 (JP) 2005092325

(51) Int. Cl. H01M 8/04

(52) U.S. Cl. CPC H01M 8/04201; H01M 8/04097
USPC 429/414; 429/513

(57) ABSTRACT

A fuel cell system includes a fuel cell and an ejector. The ejector includes a nozzle portion having openings provided at its distal and proximal ends for injecting drive-stream gas; a diffuser portion provided on a distal end side of the nozzle portion for drawing in auxiliary gas by negative pressure which is generated in the drive-stream gas by injection from the nozzle portion so as to join the auxiliary-stream gas together with the drive-stream and discharge the drive-stream gas and the auxiliary gas; a needle slidably inserted into an interior of the nozzle portion in an axial direction of the nozzle portion for adjusting an opening area of the nozzle portion in accordance with an inserted position thereof; a drive unit for moving the needle axially; and an auxiliary stream gas introducing portion including at least two openings for introducing the auxiliary-stream gas into the diffuser portion therefrom.

The present invention claims foreign priority to Japanese patent application No. P.2005-092325, filed on Mar. 28, 2005, the contents of which is incorporated herein by reference.

### BACKGROUND OF THE INVENTION

1. Field of the Invention

The present invention relates to an ejector which has a configuration in which an auxiliary-stream gas is made to join a drive-stream gas for discharge the drive-stream gas and the auxiliary-stream gas therefrom.

2. Description of the Background Art

There has been proposed a technique in which an ejector is used as a hydrogen circulating pump in a fuel cell system. The ejector is such as to have a construction in which circulating hydrogen is drawn in for re-supply by making use of negative pressure produced by injecting a high-pressure fluid from a jet nozzle.

When the ejector so constructed is used, the circulating capability is limited by the diameter of the jet nozzle, and hence, there occurs a case where the ejector is not suitable for a fuel cell system having a large flow rate range such as one for a motor vehicle.

On the contrary, Japanese Patent Unexamined Publication No. JP-A-8-338398 proposes a technique in which the opening area of an injection nozzle is adjusted by axially moving a cylindrical adjusting rod (a needle).

Incidentally, depending on the production accuracy of constituent components of an ejector such as a needle and its guide member or an actuator for moving the needle, a needle set in a nozzle is caused to deviate minutely from an axial direction thereof. In the event that a configuration such as seen in the aforementioned technique is adopted for the ejector like this in which an auxiliary-stream gas is caused to simply hit the needle, there is caused a problem in the drawing force and drawing amount of the auxiliary stream.

The problem will be described using FIGS. 4, 5. FIGS. 4 and 5 are drawings which illustrate a main part of a conventional ejector to describe the problem inherent therein. Firstly, in the event that a distal end portion of a needle 33 is displaced in a direction in which the distal end portion moves away from an auxiliary-stream gas (namely, in a direction which follows an arrow A in FIG. 4), an opening area of a location of a distal end portion of a nozzle 32 which lies near the auxiliary-stream gas (namely, a lower region of the distal end portion of the nozzle 32) is increased. As a result, a drawing force exerted on the auxiliary-stream gas by a driven steam of gas is increased, whereby the flow rate of the auxiliary-stream gas is increased excessively (refer to FIG. 4).

In contrast, in the event that the distal end portion of the needle 33 is displaced in a direction in which the distal end portion approaches the auxiliary-stream gas (namely, in an opposite direction to an arrow A in FIG. 5) due to the pressure of the auxiliary-stream gas, an opening area of a location of the distal end portion of the nozzle which lies away from the auxiliary-stream gas (namely, an upper region of the distal end portion of the nozzle 32) is increased. As a result, the drawing force exerted on the auxiliary-stream gas by the drive-stream gas is decreased, whereby the flow rate of the auxiliary-stream gas is decreased excessively (refer to FIG. 5).

Thus, there exists a problem where an accurate control of the drawing force and drawing amount of the auxiliary-stream gas becomes difficult to be implemented. In particular, in a case where an ejector is installed in a fuel cell system in which an unreacted off-gas is circulated, the unreacted off-gas constitutes an auxiliary stream, and since the flow rate and flow velocity of the auxiliary stream can affect power generating conditions, controlling the flow rate and flow velocity of the auxiliary stream becomes crucial to secure a desired power generation performance, as well. While it is considered as a means for attaining this to configure the needle to follow precisely the axis thereof in a perfect fashion when it slides, there is caused a problem where since a severe accuracy which is required for production deteriorates the productivity, the attempt is unrealistic.

### SUMMARY OF THE INVENTION

Consequently, an object of the invention is to provide an ejector which can control the flow rate and flow velocity of the auxiliary-stream gas with good accuracy.

According to a first aspect of the invention, there is provided an ejector comprising:

a nozzle portion (for example, a nozzle 32 in an embodiment which will be described later on) having openings provided at a distal end and a proximal end thereof, respectively, for injecting drive-stream gas;

a diffuser portion (for example, a diffuser 31 in the embodiment which will be described later on) provided on a distal end side of the nozzle portion for drawing in auxiliary gas by negative pressure which is generated in the drive-stream gas by injection from the nozzle portion so as to join the auxiliary-stream gas together with the drive-stream and discharge the drive-stream gas and the auxiliary gas;

a needle (for example, a needle 33 in the embodiment which will be described later on) slidably inserted into an interior of the nozzle portion in an axial direction of the nozzle portion for adjusting an opening area of the nozzle portion in accordance with an inserted position thereof;

a drive unit (for example, a solenoid 11 in the embodiment) for moving the needle axially; and

an auxiliary stream introducing portion (for example, an auxiliary-stream gas introducing portion 13 in the embodiment) comprising at least two openings for introducing the auxiliary-stream gas into the diffuser portion therefrom.

According to the first aspect of the invention, since the auxiliary-stream gas is introduced from at least two openings in the auxiliary stream introducing portion, the auxiliary-stream gas is allowed to be introduced from a plurality of directions relative to the needle, and as a result, the pressure exerted on the needle from the auxiliary-stream gas can be dispersed relative to the axial direction of the needle. Consequently, deviations in drawing force and drawing amount triggered by the deviation of the needle from the axial direction thereof can be suppressed, whereby since the opening area and opening region of the nozzle portion can be maintained in originally designed states, the drawing force and drawing amount of the auxiliary-stream gas can be controlled with good accuracy without being affected by the deviation of the needle from the axial direction thereof.

According to a second aspect of the invention, as set forth in the first aspect of the present invention, it is preferable that the ejector further comprising a buffer chamber provided on an upstream side of the auxiliary stream introducing portion,

wherein the auxiliary-stream gas is adopted to be introduced into the plurality of openings from the buffer chamber.

According to the structure, since an auxiliary-stream gas can be distributed to each of the openings via the buffer chamber without having to have a configuration in which piping is individually connected to each auxiliary stream introducing portion, auxiliary-stream gas can easily be supplied to the diffuser portion from multiple directions.

According to a third aspect of the invention, as set forth in the first aspect of the present invention, it is preferable that the ejector is used on a fuel cell system.

According to the structure, since the drawing force and drawing amount of auxiliary-stream gas can be controlled with good accuracy regardless of the shaft position of the needle, an easy and fine control of the flow of fuel cell system gas can be implemented, whereby the power generation stability of the fuel cell can be enhanced.

According to a fourth aspect of the present invention, as set forth in the first aspect of the present invention, it is preferable that the openings of the auxiliary stream introducing portion are arranged along with a circumferential direction of the diffuser portion.

According to a fifth aspect of the present invention, as set forth in the first aspect of the present invention, it is preferable that the openings of the auxiliary stream introducing portion are arranged in point symmetry manner relative to a central axis of the needle.

According to the first aspect of the invention, since the opening area and opening region of the nozzle portion can be maintained in the originally designed states, the drawing force and drawing amount of the auxiliary-stream gas can be controlled with good accuracy.

According to the second aspect of the invention, the auxiliary-stream gas can easily be supplied to the diffuser portion from multiple directions.

According to the third aspect of the invention, the power generation stability of the fuel cell can be enhanced.

### BRIEF DESCRIPTION OF THE DRAWINGS

FIG. 1 is a drawing which illustrates the configuration of a fuel cell system which includes a variable flow rate ejector according to an embodiment of the invention;

FIG. 2 is a side sectional view of the variable flow rate ejector according to the embodiment of the invention;

FIG. 3 is an explanatory drawing which illustrates the flow of auxiliary-stream gas of the variable flow rate ejector according to the embodiment of the invention;

FIG. 4 is a drawing depicting a main part of a conventional ejector which illustrates a problem inherent therein; and

FIG. 5 is a drawing depicting the main part of the conventional ejector which illustrates a problem inherent therein.

### DETAILED DESCRIPTION OF THE PREFERRED EMBODIMENTS

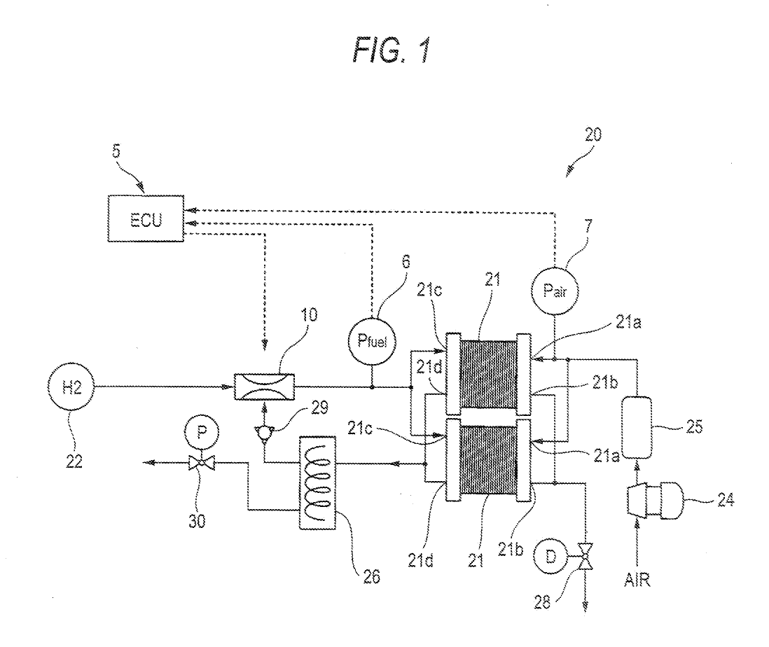

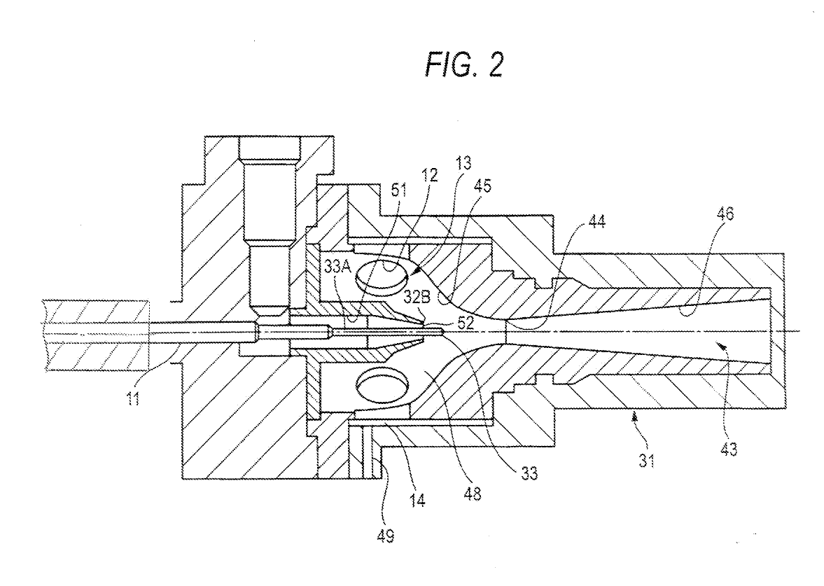

Hereinafter, a variable flow rate ejector according to an embodiment of the invention will be described by reference to the accompanying drawings. FIG. 1 is a drawing which shows the configuration of a fuel cell system 20 including a variable flow rate ejector 10 according an embodiment of the invention, and FIG. 2 is a side sectional view of the variable flow rate ejector 10 according to the embodiment of the invention. The variable flow rate ejector 10 according to the embodiment of the invention is provided in the fuel cell system 20 which is installed on a vehicle such as an electric vehicle, and this fuel cell system 20 is made up of the variable flow rate ejector 10, fuel cells 21, an oxidant supply unit 24, a heat exchanger 25 and a water separator 26.

The fuel cell 21 is made up of a stack which includes a plurality of stacked cells, each formed by holding a solid polymer electrolyte membrane, which is, for example, a solid polymer ion exchange membrane by an anode and a cathode from both sides thereof and includes a fuel electrode to which, for example, hydrogen is supplied as a fuel; and an air electrode to which, for example, air containing oxygen is supplied as an oxidant.

An air supply port 21a into which air is supplied from the oxidant supply unit 24 and an air discharge port 21b having provided therein an air discharge valve 28 for discharging air or the like in the air electrode to the outside are provided on the air electrode. On the other hand, a fuel supply port 21c to which hydrogen is supplied and a fuel discharge port 21d for discharging hydrogen or the like in the fuel electrode to the outside are provided on the fuel electrode.

The oxidant supply unit 24 is made up of, for example, a compressor and is controlled in response to a load applied to the fuel cell 21, an input signal from an accelerator pedal (not shown) and the like, so as to supply air to the air electrode of the fuel cell 21 via the heat exchanger 25. The heat exchanger 25 cools air sent from the oxidant supply unit 24 down to a predetermined temperature for supply to the fuel cell 21.

Hydrogen, which functions as fuel, is supplied from the fuel supply port 21c to the fuel electrode of the fuel cell 21 via the variable flow rate ejector 10. Furthermore, a discharged fuel which is discharged from the fuel discharge portion 21d of the fuel cell 21 is introduced into the variable flow rate ejector 10 through a check valve 29 after water is removed therefrom at the water separator 26, and as will be described later on, fuel and the discharged fuel discharged from the fuel cell 21 are made to join or mix with each other for supply to the fuel cell 21. Note that water separated from the discharged fuel at the water separator 26 is discharged to the outside by opening a drain valve 30.

The variable flow rate ejector 10 according to the embodiment of the invention is such as to make a discharged fuel circulated from the fuel cell 21 join a stream of fuel gas supplied from the fuel supply unit 22 by making use of the stream of fuel gas so supplied and to control the flow rate of fuels supplied to the fuel cell 21 based on an air pressure Pair on the air electrode side of the fuel cell 21 which is detected by a pressure sensor 7 and a fuel pressure Pfuel on the fuel electrode side of the fuel cell 21 which is detected by a pressure sensor 6 when receiving a control instruction from an ECU 5 and is configured to include, as shown in FIG. 2, a diffuser 31, a nozzle 32 and a needle 33.

A fluid passageway 43 is formed in the diffuser 31 in such a manner as to penetrate axially the diffuser 31 on a downstream side thereof. The fluid passageway 43 has a throat portion 44 where an inside diameter thereof becomes minimum at a position along the length thereof, and a throttle portion 45 is provided upstream of the throat portion 44 which has an inner circumferential surface which diametrically contracts gradually and continuously as it proceeds downstream, and a diametrically expanding portion 46 is provided downstream of the throat portion 44 which has an inner circumferential surface which diametrically expands gradually and continuously as it proceeds downstream.

The nozzle 32 is provided in an interior of the diffuser 31 in such a manner as to protrude coaxially with the diffuser 31 towards an upstream side of the fluid passageway 43.

A fluid passageway 51 is formed in an interior of the nozzle 32 in such a manner as to extend along an axial direction of the nozzle 32. An inner circumferential surface 32A, which constitutes a wall surface of the fluid passageway 51, is formed at a distal end portion of the nozzle 32 in such a manner as to diametrically contract gradually and continuously towards a distal end side thereof (a downstream side of the fluid passageway 51). A downstream end of the fluid passageway 51 continues to an opening 52 which opens at a distal end face 32b of the nozzle 32, and an upstream end of the fluid passageway 51 is blocked up by a diaphragm (not shown). A fuel supply pipe (not shown) is connected to the fluid passageway 51 for introducing thereinto fuel supplied from the fuel supply unit 22.

The needle 33 is inserted into the interior of the nozzle 32 coaxially with the nozzle 32, and the needle 33 is held by a needle holding guide (not shown) in such a manner as to slide in an axial direction which is coaxial with the nozzle 32. Here, an outer circumferential surface of the needle 33 is formed at a distal end portion of the needle 33 in such a manner as to diametrically contract gradually and continuously as it extends towards a distal end side thereof. Namely, when the needle 33 slides in the axial direction in the interior of the nozzle 32, a protruding amount of the distal end portion of the needle 33 which protrudes from the opening 52 of the nozzle 32 is changed. In association with this, an opening area of a gap between the inner circumferential surface of the nozzle 32 and the outer circumferential surface of the needle 33 is changed, whereby the flow rate of fuel that is injected into an auxiliary stream chamber 48 from the opening 52 of the nozzle 32 can be adjusted.

Note that the needle holding guide, which holds the needle 33 in such a manner as to slide relative to the axial direction, is formed into, for example, an annular disc shape having an appropriate through hole through which fluid can pass, and the needle 33 is inserted through a needle insertion hole which penetrates the annular disc in the axial direction. In addition, the needle 33 is connected electrically and mechanically to a solenoid 11, so that the needle 33 is configured to be moved back and forth in the axial direction in response to ON/OFF operations of the solenoid 11.

Additionally, an auxiliary-stream gas introducing portion 13 having a plurality of auxiliary-stream gas introducing holes 12 is formed in the auxiliary stream chamber 48 at a location which faces the outer circumferential surface of the nozzle 32. This auxiliary-stream gas introducing portion 13 is connected to an auxiliary stream introducing pipe 49, which communicates with a fuel off-gas discharge path, via a buffer chamber 14 which is formed on an outer circumferential side of the auxiliary-stream gas introducing portion 13. For an example, as shown in FIG. 2, pluralities of the auxiliary stream gas introducing holes 12 are arranged along with a circumferential direction of the diffuser 31.

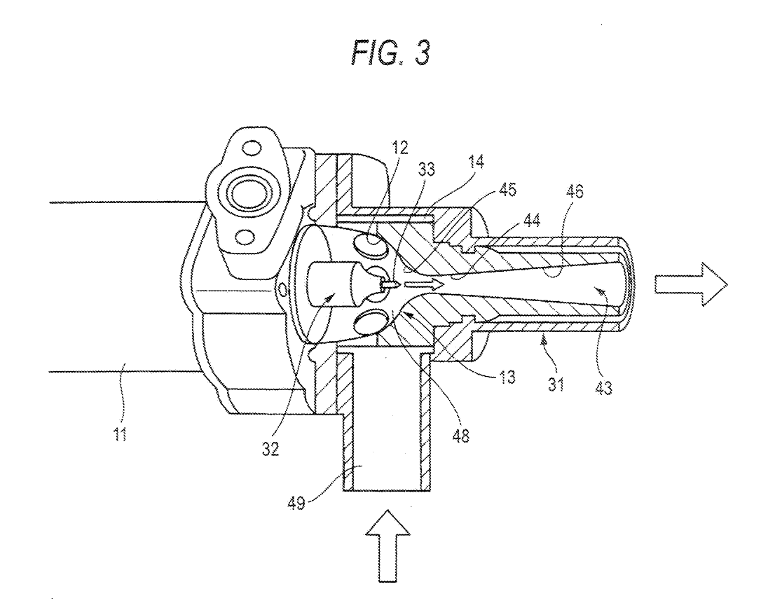

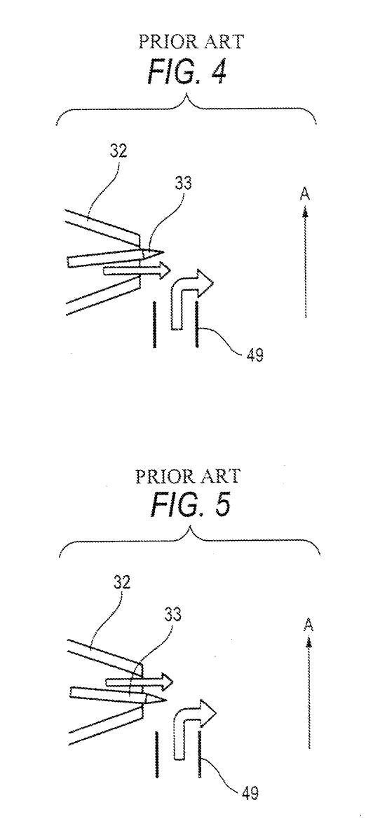

The fuel cell system 20 including the variable flow rate ejector 10 according to the embodiment of the invention is configured as has been described heretofore. Next, the operation of the variable flow rate ejector 10 will be described. FIG. 3 is an explanatory drawing which illustrates the flow of an auxiliary-stream gas in the variable flow rate ejector according the embodiment of the invention.

In this variable flow rate ejector 10, a discharged fuel gas from the fuel cell 21 is supplied thereinto from the auxiliary stream introducing pipe 49 through the plurality of auxiliary-stream gas introducing holes 12 possessed by the auxiliary-stream gas introducing portion 13 via the buffer chamber 14. In addition, a fuel is supplied into the fluid passageway 51 in the interior of the nozzle 32 from the fuel supply pipe (not shown). Then, the fuel so supplied is injected from the opening 52 of the nozzle 32, that is, the gap between the nozzle 32 and the needle 33 towards the fluid passageway 43 of the diffuser 31. As this occurs, negative pressure is produced in the vicinity of the throat portion 44 of the diffuser 31 where a high-velocity fuel stream passes, and fuel auxiliary-stream gas within the auxiliary stream chamber 48 is drawn into the fluid passageway 43 by the vacuum so produced, so as to be mixed with the fuel injected from the nozzle 32 for discharge from a downstream end of the diffuser 31, whereby the discharged fuel discharged from the fuel cell 21 is circulated via the variable flow rate ejector 10.

Thus, since the auxiliary-stream gas (in this case, the discharged fuel gas) is introduced individually from the plurality of auxiliary-stream gas introducing holes 12, the auxiliary-stream gas is introduced from a plurality of directions relative to the needle 33. As a result, a pressure that the needle 33 receives from the auxiliary-stream gas can be dispersed relative to the axial direction. Consequently, the deviation in drawing force and drawing amount of auxiliary stream that is triggered by the deviation of the needle 33 from the axial direction thereof can be suppressed, whereby since the opening area and opening region of the nozzle 32 can be maintained in the originally designed states, even in the event that the needle 33 is caused to deviate slightly from the axial direction thereof, the drawing force and drawing amount of auxiliary-stream gas can be controlled with good accuracy.

In addition, since the auxiliary-stream gas can be distributed individually to the plurality of auxiliary-stream gas introducing holes 12 via the buffer chamber 14, the auxiliary-stream gas can easily be supplied to the diffuser from multiple directions. For an example, the auxiliary-stream gas introducing holes 12 are disposed in point symmetry relative to a central axis of the needle 33, whereby the auxiliary-stream gas is dispersed, so as to hit the needle not only from the multiple direction but also in substantially the same amount, thereby making it possible to obtain an advantage where the deviation in position of the needle 33 can be suppressed. The advantage can be achieved by arranging the auxiliary-stream gas introducing holes 12 along with the circumferential direction of the diffuser 31, as described above.

In addition, by applying the ejector 10 to the fuel cell system, an easy and fine control of the stream of fuel cell system gas can be implemented, whereby the power generation stability of the fuel cell can be enhanced. Note that a space for the water separator 26 or the like is secured upstream of the ejector 10, even in the event that the buffer chamber 14 is configured to be provided in the ejector 10, an effect resulting from a reduction in sucking amount can be suppressed.

Thus, as has been described heretofore, according to the ejector of the embodiment of the invention, the control of drawing force and drawing amount of auxiliary-stream gas can be implemented with good accuracy.

Note that the contents of the invention are, of course, not limited to the embodiment. For example, while in the embodiment, the ejector is described as being applied to the fuel cell system, the ejector can be applied to other systems.

While there has been described in connection with the preferred embodiments of the present invention, it will be obvious to those skilled in the art that various changes and modification may be made therein without departing from the present invention, and it is aimed, therefore, to cover in the appended claim all such changes and modifications as fall within the true spirit and scope.

1. A fuel cell system comprising:
a fuel cell; and
an ejector, the ejector comprising:
a nozzle portion having openings provided at a distal end and a proximal end thereof, respectively, for injecting drive-stream gas;
a diffuser portion provided on a distal end side of the nozzle portion for drawing in auxiliary gas by negative pressure which is generated in the drive-stream gas by injection from the nozzle portion so as to join the auxiliary-stream gas together with the drive-stream and discharge the drive-stream gas and the auxiliary gas;
a needle slidably inserted into an interior of the nozzle portion in an axial direction of the nozzle portion for adjusting an opening area of the nozzle portion in accordance with an inserted position thereof;
a drive unit for moving the needle axially; and
an auxiliary stream gas introducing portion comprising at least two openings for introducing the auxiliary-stream gas into the diffuser portion therefrom.

2. The fuel cell system as set forth in claim 1,
wherein the ejector further comprises: a buffer chamber provided on an upstream side of the auxiliary stream gas introducing portion, and
wherein the auxiliary-stream gas is adopted to be introduced into the plurality of openings from the buffer chamber.

3. (canceled)

4. The fuel cell system as set forth in claim 1, wherein the openings of the auxiliary stream gas introducing portion are arranged along with a circumferential direction of the diffuser portion.

5. The fuel cell system as set forth in claim 1, wherein the openings of the auxiliary stream gas introducing portion are arranged in point symmetry manner relative to a central axis of the needle.

6. The fuel cell system as set forth in claim 1, further comprising:
a water separator provided on an exhaust fuel side and configured to recirculate the exhaust fuel from the fuel cell.

7. The fuel cell system as set forth in claim 1,
wherein the at least two openings for introducing the auxiliary-stream gas are disposed on an upstream side of the nozzle.

8. The fuel cell system as set forth in claim 1,
wherein an outer diameter of a distal end portion of the needle gradually decreases towards a distal end thereof.
